(19) United States
(12) Patent Application Publication
(10) Pub. No.: US 2013/0177196 A1
(43) Pub. Date: Jul. 11, 2013

(54) Magnetically Attachable Exterior Grills for Speaker Housing

(71) Applicant: Noel Lee, Las Vegas, NV (US)

(72) Inventor: Noel Lee, Las Vegas, NV (US)

(21) Appl. No.: 13/346,611

(22) Filed: Jan. 9, 2012

(51) Int. Cl. H04R 1/02; B23P 11/00

(52) U.S. Cl. 381/391; 29/525.08

(57) ABSTRACT

A speaker housing or module facilitates the interchanging or swapping of designer grills outside the speaker housing without further disassembly and reassembly. There are one or more magnets located in the speaker housing that enable various patterns of acoustically permeable designer grills to be attached to the outside of the speaker housing or module. Magnets are disposed at locations within the speaker housing that align with magnetically attractive elements on the speaker grills to facilitate quick and easy replacement or exchange of the grills according to user preference.

### FIELD OF THE INVENTION

The present invention relates generally to a system and method for interchanging the grills covering the speakers of a commercial or home sound system.

### BACKGROUND OF THE INVENTION

Most sound systems, once purchased, look the same for as long as consumers continue to use them. However, many consumers and commercial establishments having sound systems, such as movie theaters, would like to be able to change the outside appearance of their systems without replacing one or more components of the system. Therefore, it is desirable to provide speaker systems whose look can be conveniently changed by the user by simply replacing the speaker grills.

### BRIEF SUMMARY OF THE INVENTION

A speaker housing or module according to the present invention facilitates the interchanging or swapping of designer grills outside the speaker housing without further disassembly and reassembly. There are one or more magnets located in the speaker housing that enable various patterns of designer grills to be attached to the outside of the speaker housing or module. Magnets are disposed at strategic locations on the speaker output side of the speaker housing or module. Similarly, magnets of opposite polarity or magnetically attracting metal elements, are disposed at corresponding locations on the inside mounting surfaces of the grills. By simply detaching one speaker grill, the user can replace the grill with a similarly constructed speaker grill having a different decorative design. Thus, changing a speaker grill according to the present invention requires no further disassembly or reassembly of the speaker housing.

Acoustically permeable grills form the front and/or rear of the speaker housing to complete the speaker housing enclosure. One object and advantage of the present invention is to provide a way to easily and inexpensively change the exterior look of speakers by exchanging the grill design of the speaker module without additional disassembly or reassembly.

### BRIEF DESCRIPTION OF THE DRAWINGS

FIG. 1 is a cross sectional perspective view of the speaker system with magnets.

FIG. 2 is a perspective view of a magnetically attachable grill.

FIG. 3 is a perspective view of the grills being attached to the speaker magnets.

FIG. 4 is grills attached on top of the speaker magnets.

### DETAILED DESCRIPTION OF TI-IE INVENTION

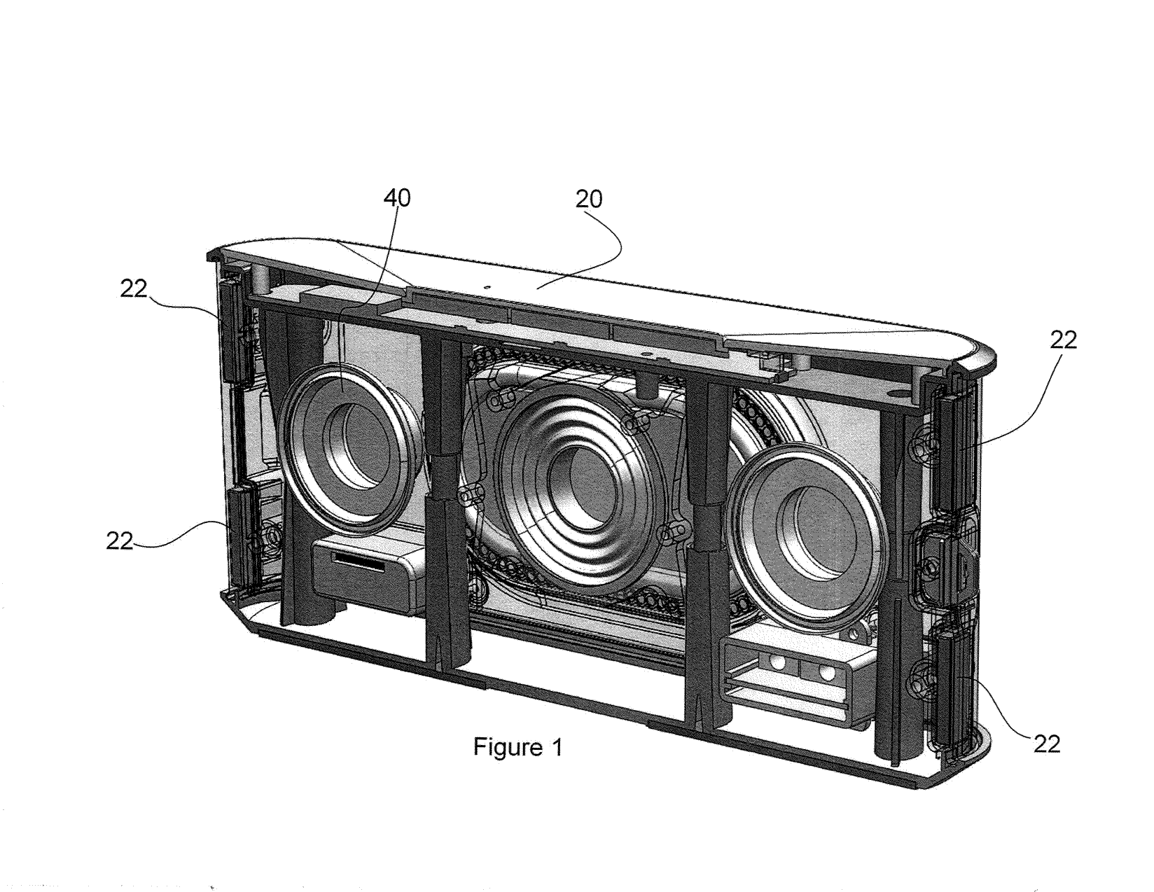

FIG. 1 is a cross sectional perspective view of speaker housing 20 with magnets 22 incorporated into the speaker housing 20 to allow for easy attachment/removal of interchangeable speaker grills 30. The speaker housing 20 includes speakers 40, and the speaker housing magnets 22 at each corner of the speaker housing 20. The speaker housing magnets 22 enable various grill 30 designs to be easily incorporated into the speaker housing 20 to change the appearance of the speaker system according to the preference of the consumer. It should be noted that the speaker housing 20 can also include other components, such as audio source and amplification devices. The audio source components can include digital or analog sources, including record, tape, CD, MP3, etc.

The speaker housing 20 will have a height, width and a depth. The embodiment shown in FIG. 1 discloses a speaker housing 20 where the width is greater than the height or the depth. An alternative embodiment could have other dimensions, such as where the height exceeds the width. In the embodiment shown here, the housing magnets 22 traverse the depth of the speaker housing 20. This configuration allows separate grills 30 (e.g. front and rear) to utilize the same magnets. For instance, one speaker magnet that traverses the depth of the housing 20 can be used to attach both a front grill and a rear grill.

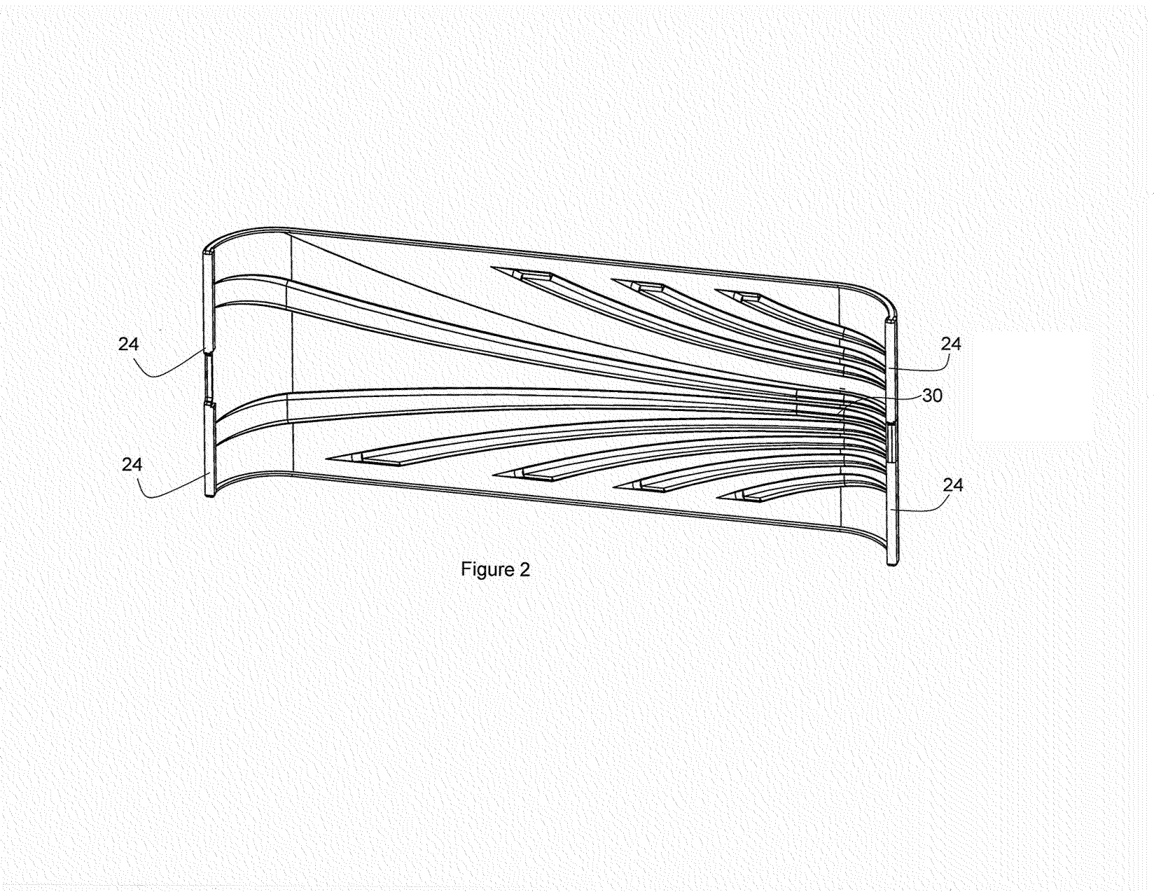

FIG. 2 is a perspective view of an interchangeable grill 30, having an exterior design. Interchangeable Grill 30 incorporates magnetically attractive metal 24 at locations corresponding to housing magnets 22. Housing magnets 22 magnetically attract and hold the magnetically attractive metal element 24 to secure the grill and complete the housing 20. A virtually unlimited variety of grill designs can be incorporated into the interchangeable grills 30. The corners of the grill design 30 have metals attached at the end of the grill corners directly aligning with the grill magnets 22 inside the speaker housing 20. The replaceable grill designs, including front and rear, can be varied and envelope the front and rear portions of the speaker housing 20. Other embodiments of this system could utilize fewer magnets than shown here, including where there is only one or two housing magnets. However, to properly secure the grill 30 onto the speaker housing 20, there are preferably magnets in each corner of the speaker housing 20. This configuration encourages a secure connection between the grill 30 and the speaker housing 20, without vibrations between the two.

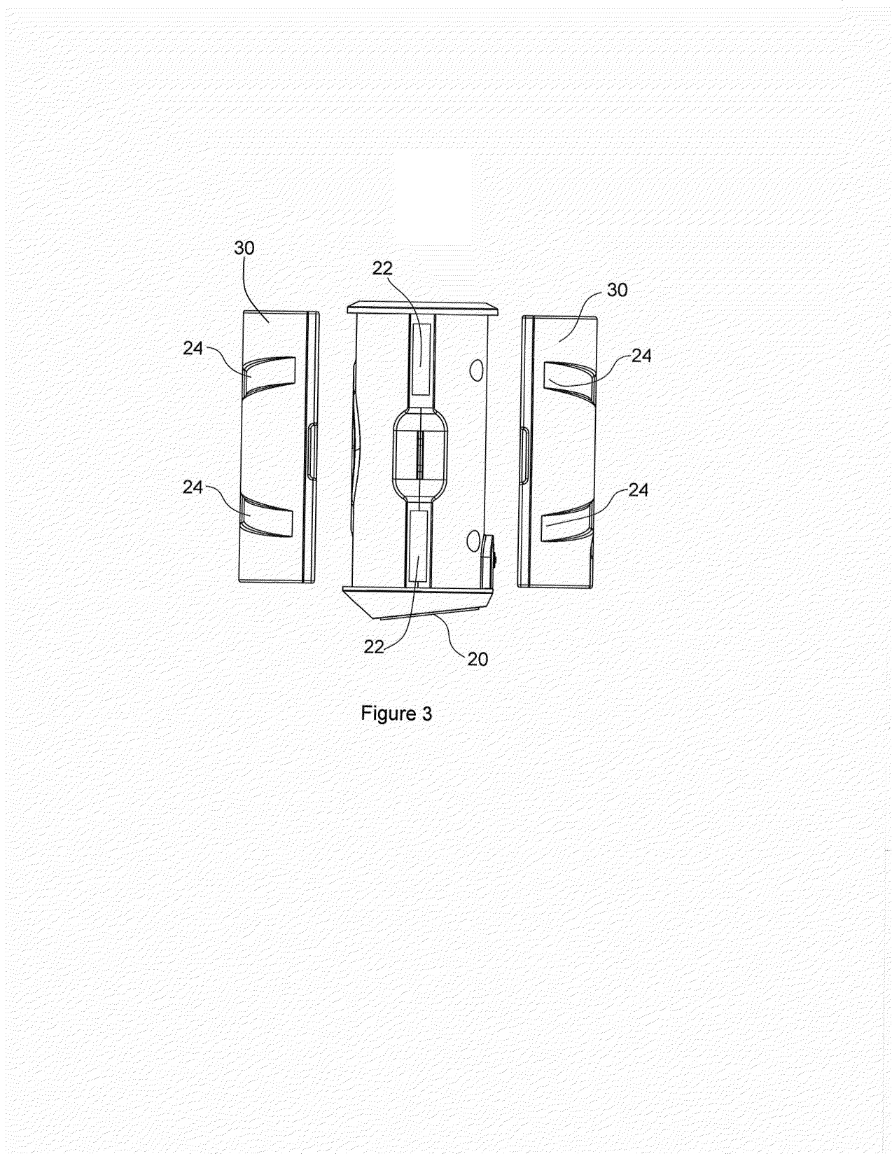

FIG. 3 illustrates an exploded top down view of the speaker housing 20, showing both front and rear grills 30 in a detached condition. The corners of the grill 30 incorporate magnetically attractive metal elements 24, shown aligned with the housing magnets 22. The grills 30 can be made of any acoustically permeable material such as fabric, plastic, or a composite, and can also include one or more apertures to improve the sound transmission through the grills.

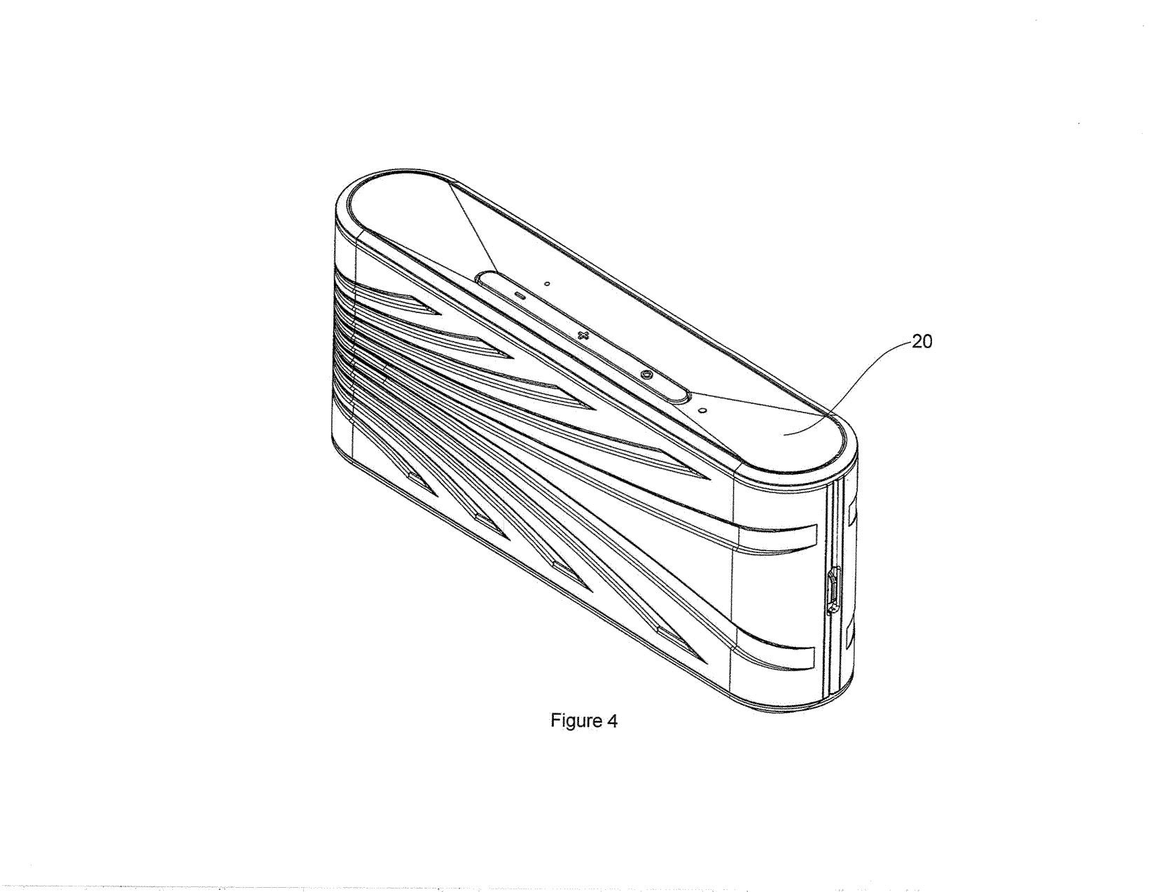

FIG. 4 illustrates a front perspective view of the grill 30 attached to the speaker housing 20. The grill 30 is interchangeable with grills of other designs and exterior looks, as long as they are sized and shaped to attach to the speaker housing 20.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention.

What is claimed is:

1. A speaker system comprising:
a. a speaker housing having one or more speaker housing magnets;
b. one or more interchangeable grill, each grill comprising one or more magnetically attractive metal elements corresponding to the speaker housing magnets, to attach the grill to the speaker housing.

2. The speaker system of claim 1, further comprising a front grill and a rear grill.

3. The speaker system of claim 1, wherein the interchangeable speaker grill is made from acoustically permeable material.

4. A speaker system comprising:
a. a speaker housing having one or more magnetically attractive metal elements;
b. one or more interchangeable grills, each grill comprising one or more magnets corresponding to the magnetically attractive metal elements of the speaker housing to couple the speaker housing and the interchangeable grill.

5. The speaker system of claim 4, further comprising a front interchangeable grill and a rear interchangeable grill.

6. The speaker system of claim 4, wherein the interchangeable speaker grill is made from acoustically permeable material.

7. A method for attaching multiple speaker grill designs to a speaker housing, comprising:
a. disposing a plurality of magnets on the speaker housing;
b. attaching a first grill onto the speaker housing, the first grill having a first exterior design, wherein the first grill comprises magnetically attractive elements that align with the plurality of magnets on the speaker housing; and
c. removing the first grill from the speaker housing and attaching a second grill onto the speaker housing, the second grill having a second exterior design, wherein the second grill comprises magnetically attractive elements that align with the plurality of magnets on the speaker housing.
